(19) United States
(12) Patent Application Publication
(10) Pub. No.: US 2011/0240676 A1
(43) Pub. Date: Oct. 6, 2011

(54) Defensive spray container

(76) Inventor: Kenneth J. McDonald, Sussex, NJ (US)

(21) Appl. No.: 12/798,337

(22) Filed: Apr. 2, 2010

(51) Int. Cl. B65D 37/00; B05B 11/04; B65D 47/04

(52) U.S. Cl. 222/211; 222/212; 222/546

(57) ABSTRACT

The disclosure is directed to a defensive spray container. It includes a standard plastic material bottle which can be squeezed to expel a fluid contained in the bottle. The fluid is of such a nature to immediately disabled a person against whom the fluid is directed. The bottle has a screw cap on top of its neck. The screw cap supports an aspirator tube within the bottle. The aspirator tube is open at the top of the screw cap. The opening of the aspirator tube is sealed by way of a knock-off cap which has on its interior bottom a cone-shaped nipple which sealingly engages the opening in the aspirator tube. When a defensive need arises, the holder of the defensive spray container merely has to dislodge the knock-off cap to open the opening in said aspirator tube and a forceful squeeze of the bottle will forcefully eject the disabling fluid from the bottle.

### CROSS REFERENCES TO RELATED APPLICATIONS

(none)

### STATEMENT REGARDING FED SPONSORED R & D

(none)

### REFERENCE TO MICROFICHE APPENDIX

(none)

### BACKGROUND OF THE INVENTION

This invention is a variation or an improvement over applicant's prior U.S. Pat. No. 5,826,796 and pertains to a container having a defensive liquid therein. By defensive liquid is meant a liquid that immediately will disable a person, if the person is an attacker when dispensed onto the face of that person or attacker. The liquid will disable the person for a certain period time so that said person is disabled for some time and is prevented from escaping. In view of the events that happened on Sept. 11 in New York City and Washington, D.C., if such a defensive spray container had been on board in any of the planes involved, most of the tragedies may have been avoided. The spray container, because of its size, could have been in the pockets of the pilot, co-pilot or any of the flight attendants because of its unobtrusive nature. Recently, there have been quite some discussions whether pilots or others on board should carry weapons such as guns. It is believed that this disabling spray would be a much better safeguard. The applicant is fully aware that the FAA prohibits any kind of pressurized defensive containers on board an aircraft, such as maze or pepper spray. Because of the fact that the disclosed defensive spray container is not pressurized at all, but is activated by hand pressure, the spray would be much more effective.

### BRIEF SUMMARY OF THE INVENTION

The invention consists of a squeezable container having a spray hole at the top. The spray hole is sealed by way of a seal which is located within an interior of the cap and the seal is inserted into the spray hole to seal the same. The cap is designed in such a way that a hard pressure from a thumb of a user on a flared edge of the cap will pop the cap off and it is ready for use without further manipulations. Another way of popping the cap off is by the flared cap against a hard edge anywhere or by dragging the cap with some force across some clothing such as trousers or jackets, for example. Further explanations will follow in some detail below.

### BRIEF DESCRIPTION OF THE DRAWINGS

FIG. 1 shows a cross section through the defensive spray container;

FIG. 2 illustrates the cap for the spray container;

FIG. 3 demonstrates the use of the defensive spray container.

### DETAILED DESCRIPTION OF THE INVENTION

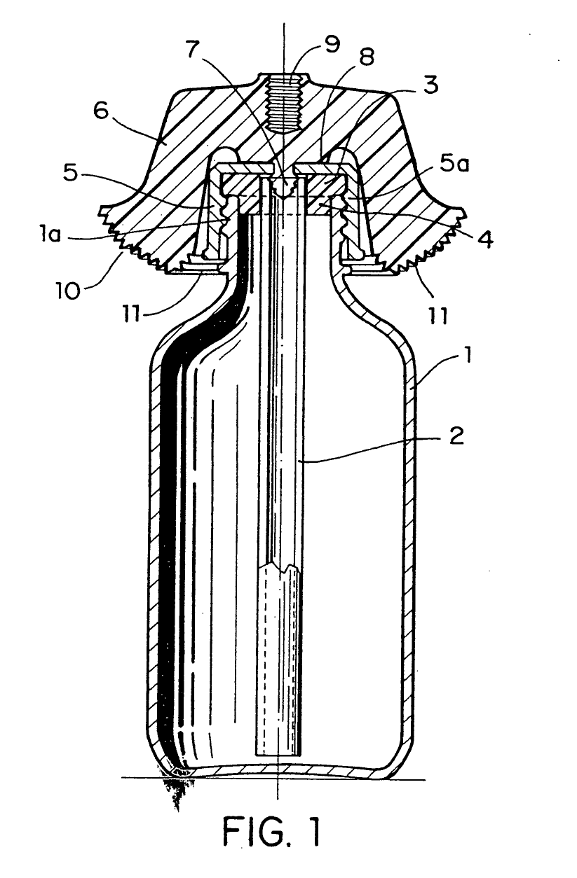

Turning now to FIG. 1, there is shown the cross section through the defensive spray container consisting of a standard bottle 1 which can be found on the open market and is made of a low density polyethylene plastic material that can be squeezed time and time again without fatiguing or cracking. This characteristic will become apparent as the description continues below. The neck of the bottle 1 has exterior screw threads la thereon to receive the screw cap 5 thereon which has interior screw threads 5a. Under the screw cap 5, there is placed and outer seal 3 which extends into an inner seal 4 which is placed inside the neck of the bottle 1. The seals 3 and 4 carry an aspiration tube 2 which will expel the fluid through an opening on top of the screw cap 5. The seals 3 and 4 can be made in one unit.

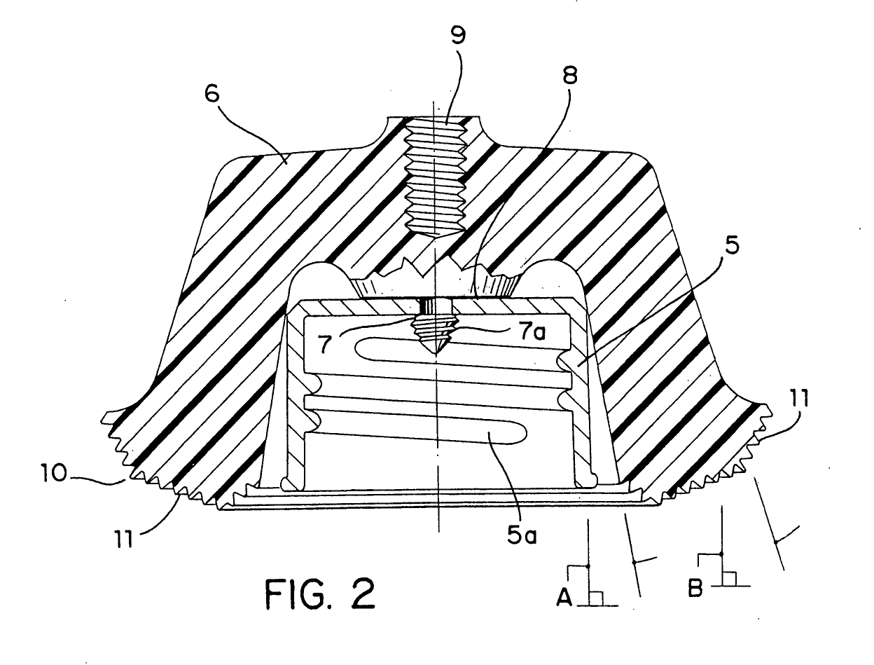

Turning now to FIG. 2 in combination with FIG. 1, the sealing but removable knock-off cap 6 provides a sealing of the fluid inside the bottle 1 by way of a tapered nipple which has ribs 7a thereon. The tapered sealing nipple is pushed into the opening of the aspiration tube to assure complete sealing of the fluid therein toward the outside ambient air. The ribs 7a assure that the nipple can easily be pushed into the opening of the top opening of the cap 5 and further into the aspiration tube 2. The ribs 7a offer a resistance against accidental removal. However, the knock-off cap is so designed that it can be knocked off the bottle 1 with some force. To this end, the knock-off cap is flared outwardly at the bottom to form a circular bulge 10 which has gripping surfaces 11 on the bottom surface. The gripping surfaces 1 are in the form of circular ribs. The knock-off cap is flared outwardly at the bottom to form an angle A between the vertical line of the cap 5 and the flared outline of the knock-off cap 6. The bulge 10 also forms an angle B between the inner flare of the knock-off cap and outer line of the knock-off cap, thus creating the bulge 10. The reference character 9 in both FIGS. 1 and 2 represents a threaded receptacle for applying the defensive spray container to other items such as a holster, for example.

### SUMMARY OF THE INVENTION

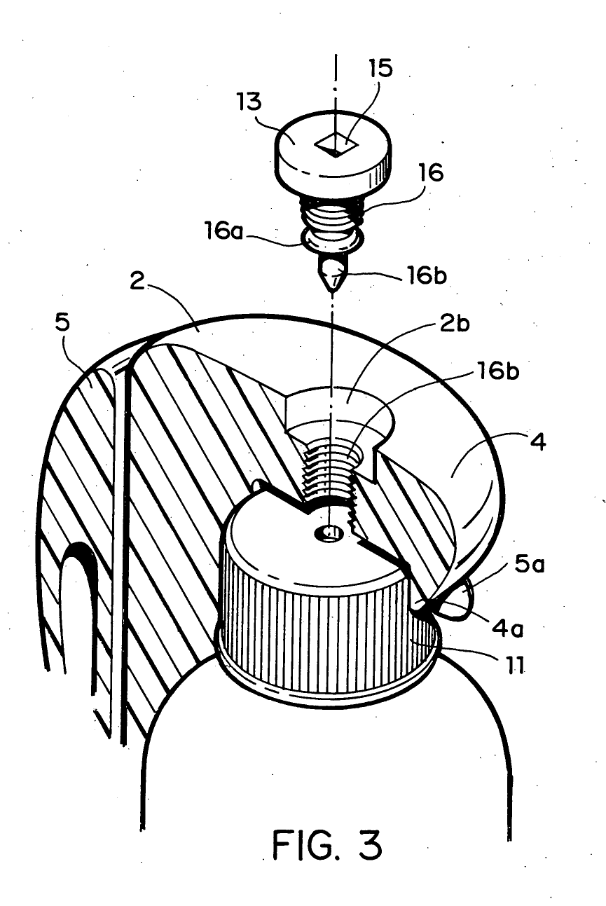

With reference to FIG. 3, the operation of the inventive device will now explained. First of all, the defensive spray container will be filled with a debilitating fluid that will instantly disable a person who is in an attacking mode. When the fluid hits a person, said person will immediately be disabled, especially with regard to its eye sight and the breathing thereafter. The fluid is not disabling on a long term basis but it is disabling long enough for anyone to take appropriate action to take charge of any perpetrator. This can be in any situation on the ground or in the air. It appears to be most effective in an airplane where any terrorist can immediately be disabled by the pilot or the flight crew when the need arises. It appears that this defensive method is far superior to anybody on the flight crew trying to defend any situation with guns. This includes the pilot, the co-pilot or the flight Marshall. The use of a gun in flight has not been resolved as of this time, because a gun with a projectile may be more dangerous when used in a pressurized air plane cabin when flying at high altitudes.

FIG. 3 shows the very simple use of the defensive spray container 1. When the need arises, a person carrying the defensive container, whether it is in the cockpit, an air flight Marshall or a flight attendant, has to merely take the container out of a pocket or where ever the container is stored, use the thump T of the hand H and under pressure flip the knock-off cap 6 off the cap 5 and the container is ready for use when pressure is applied to the container. Experiments have shown that the spray emanating from the spray container can be very accurate up to 12 feet, depending on the pressure applied to the container. If for any reason, the thump T of Hand H is insufficient to knock off the knock-off cap 6 from the cap 5, any hard surface that is available will serve the same purpose including the clothing the person is wearing will do to rip off the knock-off cap 6 by way of friction. The reason for this is because the knock-off cap has been designed with a bulge 10 at the bottom with the annual ribs 11 thereon. The knock-off cap can be made of many different materials hard or soft as long as the knock-off cap can easily be dislodged. Also various O-rings can be used to further seal the knock-off cap against fluid leakage. However, test have shown that the tapered nipple with its ribs thereon is sufficient to seal the inside fluid against leakage.

What I claim is:

1. A defensive spray container comprising a basic bottle having a defensive fluid therein, said bottle having a screw cap on top supporting an aspirator tube within said bathe, said aspirator tube having an opening open to the top of said screw cap for said fluid to escape therefrom, a knock-off cap surrounding said screw cap and having an interior nipple for sealing said opening of said aspirator tube, whereby, when said knock-off cap is forcefully removed from said aspirator tube, said fluid will be forcefully expelled from said container when a squeezing force is applied to an outside of said container.

2. The defensive spray container of claim 1, wherein said nipple of said knock-off cap has a cone shape.

3. The defensive spray container of claim 2, wherein said cone-shaped nipple has ribs thereon.

4. The defensive spray container of claim 1, wherein said knock-off cap at its interior forma an angle between a vertical line of said screw cap and an interior wall within said knock-off cap.

5. The defensive spray container of claim 4, wherein said knock-oft cap forms and angle between said interior wall and an outside line of the exterior wall of said knock-off cap thereby forming a bulge at its bottom wall.

6. The defensive spray container of claim 5, wherein said bottom wall includes friction ribs.
